(19) United States
(12) Patent Application Publication
(10) Pub. No.: US 2008/0030896 A1
(43) Pub. Date: Feb. 7, 2008

(54) Magnetic head and storage medium drive

(75) Inventor: Tomoko Kutsuzawa, Kawasaki (JP)

Correspondence Address: Patrick G. Burns;GREER, BURNS & CRAIN, LTD., Suite 2500, 300 South Wacker Drive, Chicago, IL, 60606, US

(73) Assignee: Fujitsu Limited, Kawasaki-shi (JP)

(21) Appl. No.: 11/888,475

(22) Filed: Aug. 1, 2007

(30) Foreign Application Priority Data
Aug. 2, 2006 (JP) 2006-211371

(51) Int. Cl. G11B 5/127

(52) U.S. Cl. 360/123.59

(57) ABSTRACT

A thin film magnetic head has first and second magnetic poles spaced from each other at a medium-opposed surface. A magnetic pole end layer is opposed to the second magnetic pole in a space between the first and second magnetic poles. A magnetic piece or pieces are interposed between the magnetic pole end layer and the first magnetic pole. A non-magnetic material fills a space between the magnetic pole end layer and the first magnetic pole along the medium-opposed surface. The non-magnetic material contributes to a reduction in the volume of a magnetic body between the magnetic pole end layer and the first magnetic pole. The flux path of the magnetic flux can be narrowed. The narrowed flux path contributes to a reduction in the inductance of the magnetic head. A reduced inductance enables a reliable high-frequency recordation.

### BACKGROUND OF THE INVENTION

1. Field of the Invention

The present invention relates to a magnetic head preferably utilized in a recording medium drive such as a hard disk drive.

2. Description of the Prior Art

A magnetic pole end layer is formed on the surface of a lower magnetic pole in an inductive magnetic head, for example. A non-magnetic gap layer is interposed between the magnetic pole end layer and an upper magnetic pole. A magnetic coil is located between the upper magnetic pole and the lower magnetic pole. The magnetic coil generates a magnetic field in response to supply of electric current to the magnetic coil. The non-magnetic gap layer serves to leak a magnetic flux running between the upper and lower magnetic poles out of a medium-opposed surface. The leaked magnetic flux forms a magnetic field for recordation. The magnetic field for recordation is applied to the magnetic recording disk. This results in a change in the direction of magnetization in the magnetic recording disk. Binary data is in this manner written onto the magnetic recording disk.

The inductive magnetic head desirably enjoys a reduced inductance. A reduction in the inductance of the inductive magnetic head contributes to a reliable realization of a high-frequency recordation. A reduction in the inductance requires a reduction in the length of the flux path of the magnetic coil as well as a reduction in the turns of the magnetic coil, for example. However, a reduction in the length of the flux path of the magnetic coil inevitably leads to the smaller sectional area of the magnetic coil. The smaller sectional area causes a deteriorated magnitude of the magnetic field for recordation. A reduction in the turns of the magnetic coil also causes a deteriorated magnitude of the magnetic field for recordation.

### SUMMARY OF THE INVENTION

It is accordingly an object of the present invention to provide a magnetic head of a reduced inductance.

According to the present invention, there is provided a magnetic head comprising: a first magnetic pole extending backward from its front end exposed at a medium-opposed surface; a second magnetic pole extending backward from its front end exposed at the medium-opposed surface, the second magnetic pole magnetically connected to the first magnetic pole at a position backward from the front end of the second magnetic pole; a magnetic pole end layer having the front end exposed at the medium opposed surface, the magnetic pole end layer opposed to the second magnetic pole in a space between the first and second magnetic poles; at least one magnetic piece located between the magnetic pole end layer and the first magnetic pole so as to connect the magnetic pole end layer and the first magnetic pole to each other along the medium-opposed surface; and a non-magnetic material located between the magnetic pole end layer and the first magnetic pole to fill a space between the magnetic pole end layer and the first magnetic pole along the medium-opposed surface.

The magnetic head allows the magnetic pole end layer and the magnetic piece or pieces to exist between the first and second magnetic poles. The magnetic piece or pieces are located between the magnetic pole end layer and the first magnetic pole. When magnetic bit data is to be written, a magnetic flux runs through the first magnetic pole, the magnetic piece or pieces, the magnetic pole end layer and the second magnetic pole. The magnetic pole end layer is opposed to the second magnetic pole between the first and second magnetic poles. The magnetic flux is leaked out of the medium-opposed surface between the first and second magnetic poles. The leaked magnetic flux forms a magnetic field for recordation. Magnetic bit data is in this manner written onto a magnetic recording medium, for example.

The magnetic head allows the non-magnetic material to exist between the magnetic pole end layer and the first magnetic pole. The non-magnetic material fills a space between the magnetic pole end layer and the first magnetic pole along the medium-opposed surface. The non-magnetic material contributes to a reduction in the volume of a magnetic body between the magnetic pole end layer and the first magnetic pole as compared with the case where a magnetic body fills the entire space between the magnetic pole end layer and the first magnetic pole. The volume of the magnetic body is reduced in the magnetic head. The flux path of the magnetic flux can be narrowed. The narrowed flux path contributes to a reduction in the inductance of the magnetic head. A reduced inductance enables a reliable high-frequency recordation. Furthermore, as long as the magnetic pole end layer has a width equal to the width of a conventional magnetic pole end layer, the magnetic field for recordation of a conventional magnitude can be maintained based on the magnetic flux running between the second magnetic pole and the magnetic pole end layer.

The magnetic head can be incorporated in a storage medium drive. The storage medium drive may comprise: an enclosure; and a magnetic head enclosed in the enclosure, for example. In this case, the magnetic head comprises: a first magnetic pole extending backward from its front end exposed at a medium-opposed surface; a second magnetic pole extending backward from its front end exposed at the medium-opposed surface, the second magnetic pole magnetically connected to the first magnetic pole at a position backward from the front end of the second magnetic pole; a magnetic pole end layer having the front end exposed at the medium opposed surface, the magnetic pole end layer opposed to the second magnetic pole in a space between the first and second magnetic poles; at least one magnetic piece located between the magnetic pole end layer and the first magnetic pole so as to connect the magnetic pole end layer and the first magnetic pole to each other along the medium-opposed surface; and a non-magnetic material located between the magnetic pole end layer and the first magnetic pole to fill a space between the magnetic pole end layer and the first magnetic pole along the medium-opposed surface.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive, HDD, as a specific example of a storage medium drive according to the present invention;

FIG. 2 is an enlarged perspective view of a flying head slider according to a specific example;

FIG. 3 is an enlarged front view of a read/write head element according to a first embodiment of the present invention observed on the flying head slider at the medium-opposed surface, namely an air bearing surface;

FIG. 4 is a vertical sectional view taken along the line 4-4 in FIG. 3;

FIG. 5 is a vertical sectional view schematically illustrating a magnetic coil formed on a lower magnetic pole;

FIG. 6 is a vertical sectional view schematically illustrating a magnetic piece formed on the lower magnetic pole;

FIG. 7 is a vertical sectional view schematically illustrating an insulating layer formed on the lower magnetic pole;

FIG. 8 is a vertical sectional view schematically illustrating the insulating layer subjected to flattening process;

FIG. 9 is a vertical sectional view schematically illustrating a magnetic coil formed on the insulating layer;

FIG. 10 is a vertical sectional view schematically illustrating a magnetic pole end layer formed on the magnetic piece;

FIG. 11 is a vertical sectional view schematically illustrating another insulating layer formed on the insulating layer;

FIG. 12 is a vertical sectional view schematically illustrating the insulating layer subjected to flattening process;

FIG. 13 is a vertical sectional view schematically illustrating a non-magnetic gap layer formed on the magnetic pole end layer;

FIG. 14 is a vertical sectional view schematically illustrating an insulating layer formed on the magnetic coil;

FIG. 15 is a vertical sectional view schematically illustrating an upper magnetic pole formed on the insulating layer;

FIG. 16 is an enlarged partial perspective view schematically illustrating a read/write head element according to a second embodiment of the present invention;

FIG. 17 is an enlarged partial perspective view schematically illustrating a read/write head element according to a third embodiment of the present invention;

FIG. 18 is an enlarged front view, corresponding to FIG. 3, of a read/write head element according to a fourth embodiment of the present invention;

FIG. 19 is a vertical sectional view taken along the 19-19 in FIG. 18;

FIG. 20 is an enlarged front view, corresponding to FIG. 3, of a read/write head element according to a fifth embodiment of the present invention;

FIG. 21 is an enlarged front view, corresponding to FIG. 3, of a read/write head element according to a sixth embodiment of the present invention;

FIG. 22 is a vertical sectional view taken along the line 22-22 in FIG. 21; and

FIG. 23 is an enlarged front view, corresponding to FIG. 3, of a read/write head element according to a specific example of the present invention.

### DESCRIPTION OF THE PREFERRED EMBODIMENT

FIG. 1 schematically illustrates the inner structure of a hard disk drive, HDD, 11 as an example of a magnetic storage medium drive according to the present invention. The hard disk drive 11 includes a box-shaped enclosure body 12 defining an inner space in the form of a flat parallelepiped, for example. The enclosure body 12 may be made of a metallic material such as aluminum, for example. Molding process may be employed to form the enclosure body 12. An enclosure cover, not shown, is coupled to the enclosure body 12. An inner space is defined between the enclosure body 12 and the enclosure cover. Pressing process may be employed to form the enclosure cover out of a plate material, for example. The enclosure body 12 and the enclosure cover in combination establish an enclosure.

At least one magnetic recording disk 13 as a storage medium is enclosed in the inner space. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, 15,000 rpm, or the like.

A head actuator member or carriage 15 is also enclosed in the inner space. The carriage 15 includes a carriage block 16. The carriage block 16 is supported on a vertical support shaft 17 for relative rotation. Carriage arms 18 are defined in the carriage block 16. The carriage arms 18 are designed to extend in a horizontal direction from the vertical support shaft 17. The carriage block 16 may be made of aluminum, for example. Extrusion molding process may be employed to form the carriage block 16, for example.

A head suspension 19 is attached to the front or tip end of the individual carriage arm 18. The head suspension 19 is designed to extend forward from the carriage arm 18. A gimbal spring, not shown, is connected to the front end of the individual head suspension 19. A flying head slider 21 is fixed on the surface of the gimbal spring. The gimbal spring allows the flying head slider 21 to change its attitude relative to the head suspension 19. An electromagnetic transducer, not shown, is mounted on the flying head slider 21 as described later in detail.

When the magnetic recording disk 13 rotates, the flying head slider 21 is allowed to receive airflow generated along the rotating magnetic recording disk 13. The airflow serves to generate a positive pressure or a lift and a negative pressure on the flying head slider 21. The flying head slider 21 is thus allowed to keep flying above the surface of the magnetic recording disk 13 during the rotation of the magnetic recording disk 13 at a higher stability established by the balance between the urging force of the head suspension 19 and the combination of the lift and the negative pressure.

When the carriage 15 is driven to swing around the vertical support shaft 17 during the flight of the flying head slider 21, the flying head slider 21 is allowed to move along the radial direction of the magnetic recording disk 13. This radial movement allows the electromagnetic transducer on the flying head slider 21 to cross the data zone between the innermost recording track and the outermost recording track. The electromagnetic transducer on the flying head slider 21 can thus be positioned right above a target recording track on the magnetic recording disk 13.

A power source 22 such as a voice coil motor, VCM, is coupled to the carriage block 16. The power source 22 allows the carriage block 16 to swing about the vertical support shaft 17. The swinging movement of the carriage block 16 realizes the swinging movement of the carriage arms 18 and the head suspensions 19.

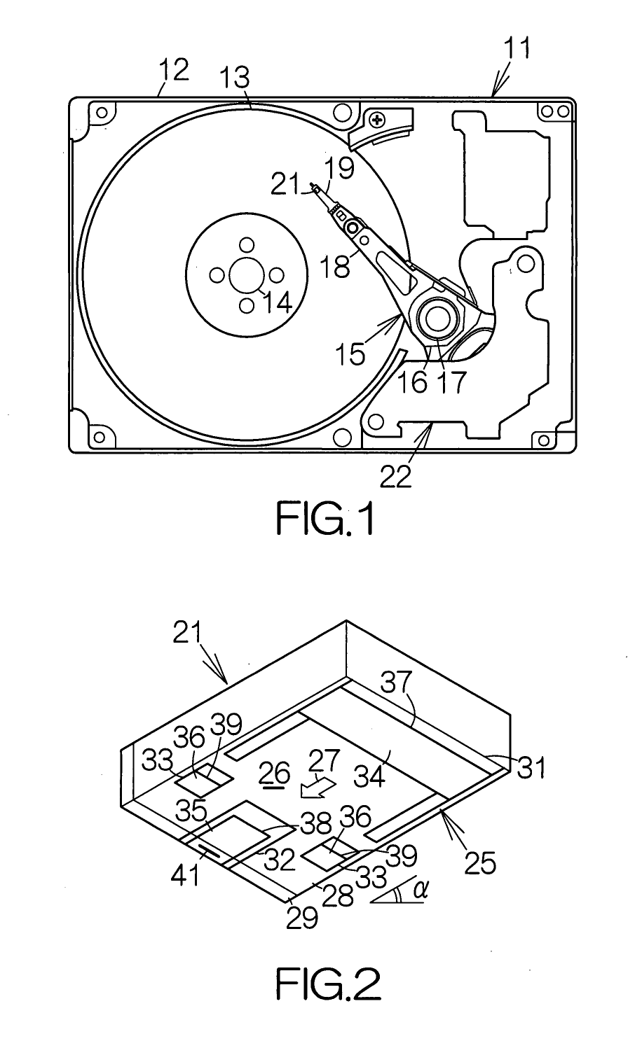

FIG. 2 illustrates a specific example of the flying head slider 21. The flying head slider 21 includes a slider body 25 in the form of a flat parallelepiped. A medium-opposed surface or bottom surface 26 is defined over the slider body 25. The slider body 25 is designed to oppose the bottom surface 26 to the magnetic recording disk 13 at a distance. A flat base surface or reference surface is defined on the bottom surface 26. When the magnetic recording disk 13 rotates, the slider body 25 receives airflow 27 at the bottom surface 26. The airflow 27 flows from the inflow or front end toward the outflow or rear end of the slider body 25. The slider body 25 may comprise a base 28 made of Al₂O₃—TiC and a head protection layer 29 made of Al₂O₃ (alumina), for example. The head protection layer 29 is overlaid on the outflow or trailing end of the base 28.

A front rail 31, a rear rail 32 and a pair of side rails 33, 33 are formed on the bottom surface 26 of the slider body 25. The front rail 31 stands upright from the flat base surface of the bottom surface 26 near the inflow end of the slider body 25. The rear rail 32 stands upright from the flat base surface of the bottom surface 26 near the outflow end of the slider body 25. The side rails 33, 33 stand upright from the flat base surface of the bottom surface 26 near the outflow end of the slider body 25. Air bearing surfaces, ABSs, 34, 35, 36 are respectively defined on the top surfaces of the front, rear and side rails 31, 32, 33. The inflow ends of the air bearing surfaces 34, 35, 36 are connected to the top surfaces of the front, rear and side rails 31, 32, 33 through steps 37, 38, 39, respectively.

The bottom surface 26 of the flying head slider 21 is designed to receive airflow 27 generated along the rotating magnetic recording disk 13. The steps 37, 38, 39 serve to generate a larger positive pressure or lift at the air bearing surfaces 34, 35, 36. Moreover, a larger negative pressure is induced behind the front rail 31. The negative pressure is balanced with the lift so as to stably establish the flying attitude of the flying head slider 21.

The aforementioned electromagnetic transducer, namely a read/write head element 41, is mounted on the slider body 25. The read/write head element 41 is embedded within the head protection layer 29 of the head slider body 25. The read/write head element 41 is designed to expose the read gap and the write gap at the air bearing surface 35 of the rear rail 32. It should be noted that the front end of the read/write head element 41 may be covered with a protection layer, made of diamond-like-carbon (DLC), extending over the air bearing surface 35. The read/write head element 41 will be described later in detail. The flying head slider 21 may take any shape or form other than the aforementioned one.

A larger positive pressure or lift is generated on the air bearing surface 34 as compared with the air bearing surfaces 35, 36 in the flying head slider 21. When the slider body 25 flies above the surface of the magnetic recording disk 13, the slider body 25 can be kept at an inclined attitude defined by a pitch angle a. Here, the term “pitch angle” is used to define an inclined angle in the longitudinal direction of the slider body 25 along the direction of the airflow.

FIG. 3 illustrates the bottom surface 26 of the flying head slider 21 in detail. The read/write head element 41 according to a first embodiment of the present invention includes a thin film magnetic head or inductive write head element 42 and a read head element 43. As conventionally known, the inductive write head element 42 utilizes a magnetic field generated at a magnetic coil so as to write bit data into the magnetic recording disk 13, for example. A magnetoresistive (MR) element such as a giant magnetoresistive (GMR) element, a tunnel-junction magnetoresistive (TMR) element, or the like, maybe employed as the read head element 43. The read head element 43 is usually allowed to detect bit data based on variation in the electric resistance in response to the inversion of polarization in the magnetic field applied from the magnetic recording disk 13.

The inductive write head element 42 and the read head element 43 are interposed between an Al₂O₃ overcoat film 44 and an Al₂O₃ undercoat film 45. The overcoat film 44 corresponds to the upper half of the aforementioned head protection film 29, while the undercoat film 45 corresponds to the lower half of the head protection film 29.

The read head element 43 includes a magnetoresistive film 46, such as a tunnel-junction film, interposed between a pair of electrically-conductive layers or lower and upper shielding layers 47, 48. The magnetoresistive film 46 is embedded in an insulating layer 49, made of Al₂O₃, for example, covering over the upper surface of the lower shielding layer 47. The upper shielding layer 48 extends along the upper surface of the insulating layer 49. The lower and upper shielding layers 47, 48 may be made of a magnetic material such as FeN, NiFe, or the like. The interval between the lower and upper shielding layers 47, 48 serves to determine a linear resolution of magnetic recordation on the magnetic recording disk 13 along the recording track.

The inductive write head element 42 includes a first magnetic pole or lower magnetic pole 51 and a second magnetic pole or upper magnetic pole 52. The lower and upper magnetic poles 51, 52 are designed to extend backward from their front ends exposed at the air bearing surface 35. The lower and upper magnetic poles 51, 52 may be made of a magnetic material such as FeN, NiFe, or the like. The lower and upper magnetic poles 51, 52 in combination establish a magnetic core of the inductive write head element 42 as described later.

A magnetic pole end layer 53 is located in a space between the lower and upper magnetic poles 51, 52. The magnetic pole end layer 53 has a front end exposed at the air bearing surface 35. The magnetic pole end layer 53 defines a layer body 53a and a front piece 53b formed on the surface of the layer body 53a. The front piece 53b is opposed to the upper magnetic pole 52. The width of the front piece 53b is set equal to that of the upper magnetic pole 52 in the lateral direction of the recording track. The width of the layer body 53a may be set considerably larger than that of the front piece 53b in the lateral direction of a recording track. The width of the layer body 53a may be set equal to that of a conventional magnetic pole end layer. The magnetic pole end layer 53 may be made of a magnetic material such as FeN, NiFe, or the like. It should be noted that the front piece 53b may be made of a magnetic material having a high saturation flux density (Bs).

A magnetic piece 54 is interposed between the magnetic pole end layer 53 and the lower magnetic pole 51. The magnetic piece 54 connects the magnetic pole end layer 53 to the lower magnetic pole 51 along the air bearing surface 35. The magnetic piece 54 may be made of a magnetic material such as FeN, NiFe, or the like. A non-magnetic material made of Al₂O₃ or the like, namely an insulating layer 55, covers over the surface of the lower magnetic pole 51 at a position adjacent to the magnetic piece 54. The insulating layer 55 fills a space between the magnetic pole end layer 53 and the lower magnetic pole 51 along the air bearing surface 35. An insulating layer 56 made of Al₂O₃ or the like covers over the surface of the insulating layer 55 at a position adjacent to the layer body 53a.

A non-magnetic gap layer 57, made of Al₂O₃ or the like, is interposed between the front piece 53b of the magnetic pole end layer 53 and the upper magnetic pole 52. When a magnetic field is generated in the aftermentioned magnetic coil, magnetic flux runs through the upper magnetic pole 52, the front piece 53b, the layer body 53a, the magnetic piece 54 and the lower magnetic pole 51 in this sequence. Likewise, magnetic flux runs through the lower magnetic pole 51, the magnetic piece 54, the layer body 53a and the front piece 53b and the upper magnetic pole 52 in this sequence. The non-magnetic gap layer 57 serves to leak the magnetic flux between the upper and lower magnetic poles 52, 51 out of the bottom surface 26. The leaked magnetic flux forms a magnetic field for recordation.

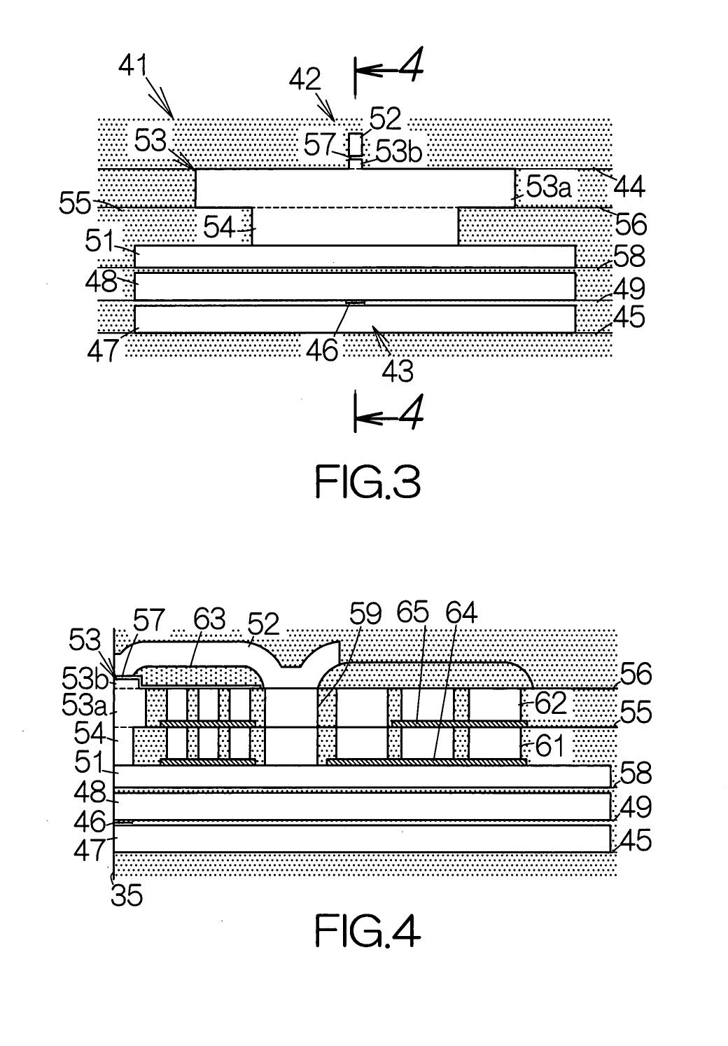

Referring also to FIG. 4, the lower magnetic pole 51 extends along the surface of a non-magnetic layer 58, made of Al₂O₃, for example, overlaid on the upper shielding layer 48 by a constant thickness. The non-magnetic layer 58 serves to magnetically isolate the upper shielding layer 48 and the lower magnetic pole 51 from each other. The magnetic coil, namely a thin film coil 61 is embedded in the insulating layer 55 on the lower magnetic pole 51. The magnetic coil, namely a thin film coil 62, is also embedded in the insulating layer 56 on the insulating layer 55.

An insulating layer 63 is overlaid on the insulating layer 56. The surface of the thin film coil 62 is thus covered with the insulating layer 63. The aforementioned upper magnetic pole 52 is formed on the insulating layer 63. The aforementioned overcoat film 44 covers over the surface of the upper magnetic pole 52. A connecting piece 59 magnetically connects the rear end of the upper magnetic pole 52 to the lower magnetic pole 51 at the central position of the thin film coils 61, 62. The connecting piece 59 is made of a magnetic material such as FeN, NiFe, or the like. The upper and lower magnetic poles 52, 51, the magnetic pole end layer 53, the magnetic piece 54 and the connecting piece 59 in combination establish a magnetic core extending through the central position of the thin film coils 61, 62.

The thin film coil 61 is designed to extend along the surface of an insulating layer 64 made of Al₂O₃, for example. The insulating layer 64 is overlaid on the lower magnetic pole 51. The thin film coil 62 is designed to extend along the surface of an insulating layer 65 made of Al₂O₃, for example. The insulating layer 65 is overlaid on the thin film coil 61. It should be noted that the thin film coils 61, 62 are electrically connected to each other. As is apparent from FIG. 4, the height of the magnetic piece 54 is set smaller than that of the layer body 53a. In this case, “height” is measured from the air bearing surface 35 in the direction perpendicular to the air bearing surface 35.

When magnetic bit data is to be written, a writing current is supplied to the thin film coils 61, 62. A magnetic field is generated at the thin film coils 61, 62 in response to the supply of the writing current. A magnetic flux in this manner runs through the lower and upper magnetic poles 51, 52, the magnetic pole end layer 53 and the magnetic piece 54. The non-magnetic gap layer 57 serves to leak the magnetic flux between the lower and upper magnetic poles 51, 52 out of the bottom surface 26. The leaked magnetic flux forms a magnetic field for recordation. Binary data is in this manner written onto the magnetic recording disk 13.

The insulating layer 55 extends between the lower magnetic pole 51 and the magnetic pole end layer 53 in the read/write head element 41. The insulating layer 55 fills a space between the lower magnetic pole 51 and the magnetic pole end layer 53 at a position adjacent to the magnetic piece 54. The insulating layer 55 contributes to a reduction in the volume of a magnetic body between the lower magnetic pole 51 and the magnetic pole end layer 53 as compared with the case where a magnetic body fills the entire space between the lower magnetic pole 51 and the magnetic pole end layer 53. The volume of a magnetic body is reduced in the inductive write head element 42. The flux path of the magnetic flux can be narrowed. This results in a reduction in the inductance of the thin film coils 61, 62. A reduced inductance enables a reliable high-frequency recordation. Furthermore, as long as the magnetic pole end layer 53 has a width equal to the width of a conventional magnetic pole end layer in the lateral direction of a recording track, the magnetic field for recordation of a conventional magnitude can be maintained based on the magnetic flux running between the upper magnetic pole 52 and the magnetic pole end layer 53.

In addition, the thin film coils 61, 62 generate heat in response to the supply of the writing current. The generated heat causes thermal expansion of the insulating layers 55, 56 as well as the lower and upper magnetic poles 51, 52. Al₂O₃ as the non-magnetic material for the insulating layers 55, 56 has a coefficient of thermal expansion smaller than that of FeN or NiFe as the material for the lower and upper magnetic poles 51, 52. Since the magnetic piece 54 has a reduced volume at a position between the lower magnetic pole 51 and the magnetic pole end layer 53, the magnetic piece 54 only suffers from a reduced thermal expansion. A reduced thermal expansion leads to suppression of protrusion of the inductive write head element 42 out of the air bearing surface 35. This results in avoidance of variation in the flying height of the flying head slider 21.

Next, a brief description will be made on a method of making the flying head slider 21. A wafer made of Al₂O₃—TiC or the like is prepared. As shown in FIG. 5, the undercoat film 45, the lower shielding layer 47, the magnetoresistive film 46, the insulating layer 49, the upper shielding layer 48, the non-magnetic layer 58 and the lower magnetic pole 51 are in this sequence overlaid on the surface of the wafer, not shown. The read head element 43 is in this manner formed. The insulating layer 64 is overlaid on the surface of the lower magnetic pole 51. Sputtering is employed to form the insulating layer 64. A resist film, not shown, may be employed to pattern the insulating layer 64 in a predetermined shape. The thin film coil 61 is formed on the surface of the insulating layer 64. Plating technique is employed to form the thin film coil 61, for example. A resist film, not shown, may be employed to pattern the thin film coil 61 in a predetermined shape.

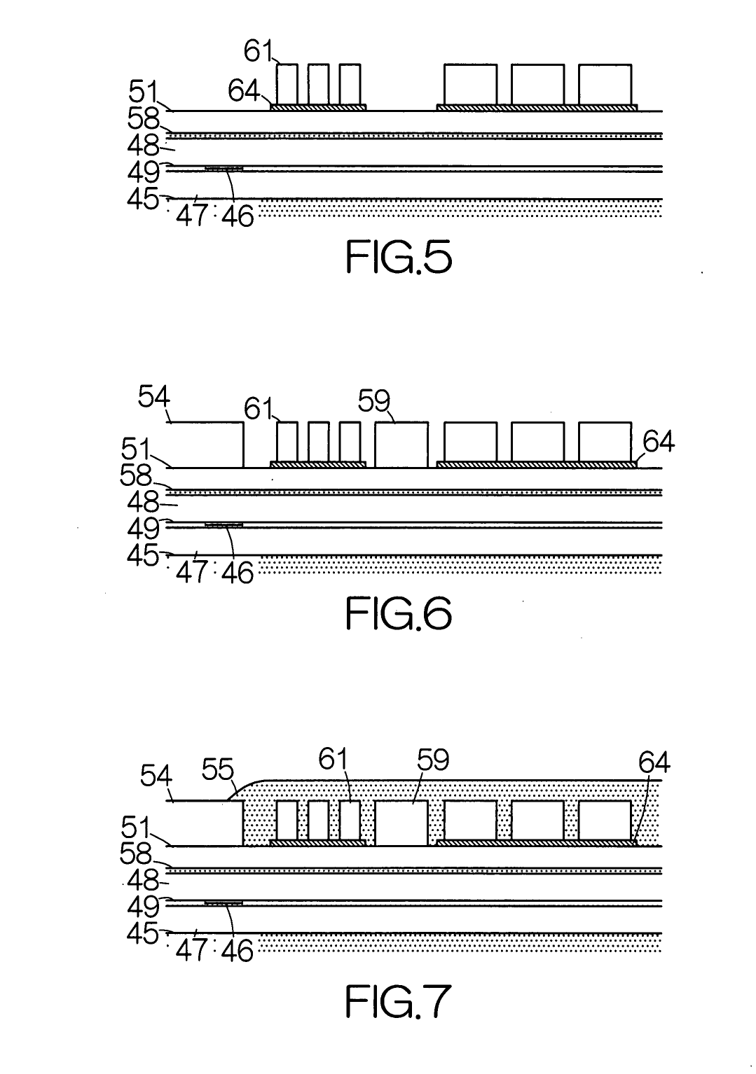

As shown in FIG. 6, the magnetic piece 54 and a lower part of the connecting piece 59 are formed on the surface of the lower magnetic pole 51 at positions outside the contour of the insulating layer 64. Plating technique is employed to form the magnetic piece 54 and the lower part of the connecting piece 59, for example. A resist film, not shown, may be employed to pattern the connecting piece 59 and the magnetic piece 54 in predetermined shapes. An insulating material is subsequently filled in gaps in the thin film coil 61, a gap between the thin film coil 61 and the connecting piece 59, and a gap between the thin film coil 61 and the magnetic piece 54. The insulating layer 55 is in this manner overlaid on the surface of the lower magnetic pole 51, as shown in FIG. 7. Sputtering may be employed to form the insulating layer 55. The magnetic piece 54, the thin film coil 61 and the connecting piece 59 are covered with the insulating layer 55 on the lower magnetic pole 51.

As shown in FIG. 8, the insulating layer 55 is subjected to flattening process. Chemical mechanical polishing (CMP) may be effected in the flattening process, for example. The magnetic piece 54, the thin film coil 61 and the connecting piece 59 get exposed at the flattened surface of the insulating layer 55. As shown in FIG. 9, the insulating layer 65 is formed on the surface of the thin film coil 61. Sputtering is employed to form the insulating layer 65. A resist film, not shown, may be employed to pattern the insulating layer 65 in a predetermined shape. The thin film coil 62 is then formed on the surface of the insulating layer 65. Plating technique is employed to form the thin film coil 62, for example. A resist film, not shown, may be employed to pattern the thin film coil 62 in a predetermined shape. In this case, the thin film coils 61, 62 may be electrically connected to each other at a position outside the contour of the insulating layer 65.

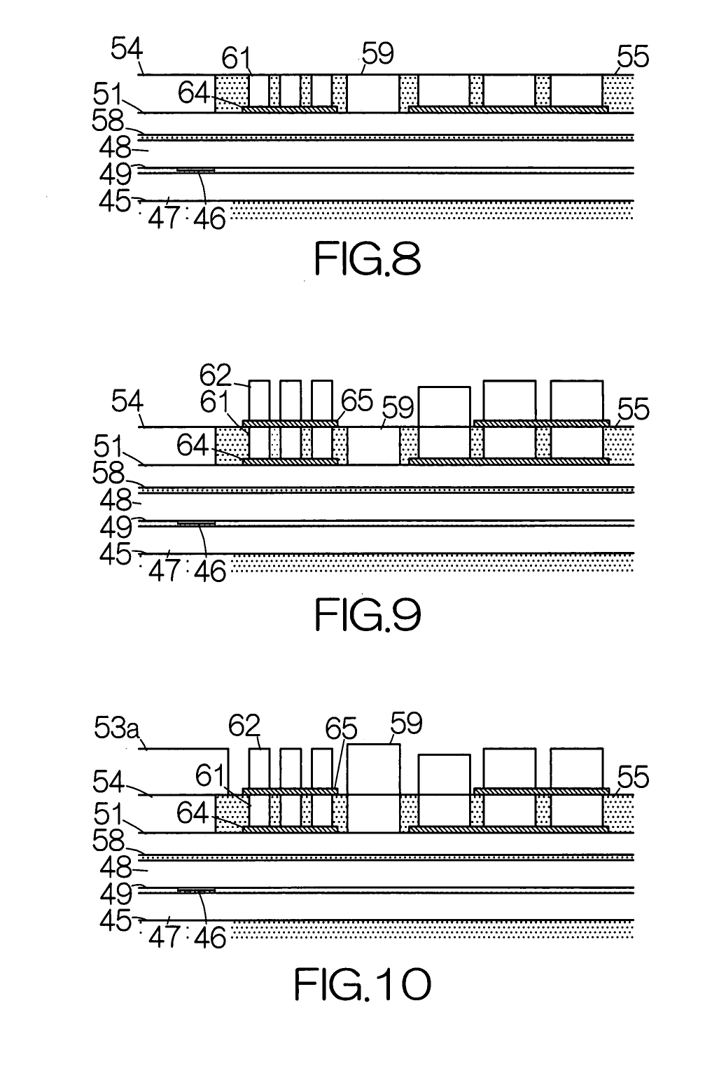

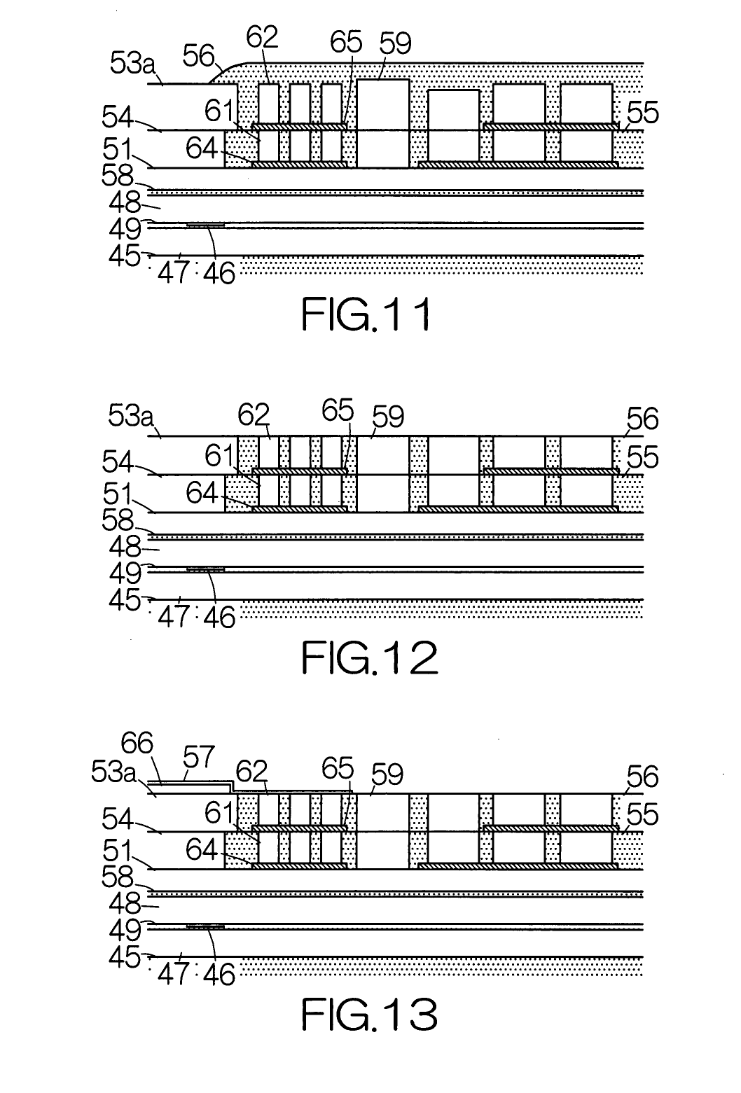

As shown in FIG. 10, the layer body 53a and an upper part of the connecting piece 59 are formed at positions outside the contour of the insulating layer 65. The layer body 53a is formed on the magnetic piece 54. An insulating material is filled in gaps in the thin film coil 62, a gap between the thin film coil 62 and the connecting piece 59, and a gap between the thin film coil 62 and the layer body 53a. The insulating layer 56 is in this manner overlaid on the surface of the insulating layer 55, as shown in FIG. 11. Sputtering may be employed to form the insulating layer 56. The layer body 53a, the thin film coil 62 and the connecting piece 59 are covered with the insulating layer 56 on the surface of the insulating layer 55.

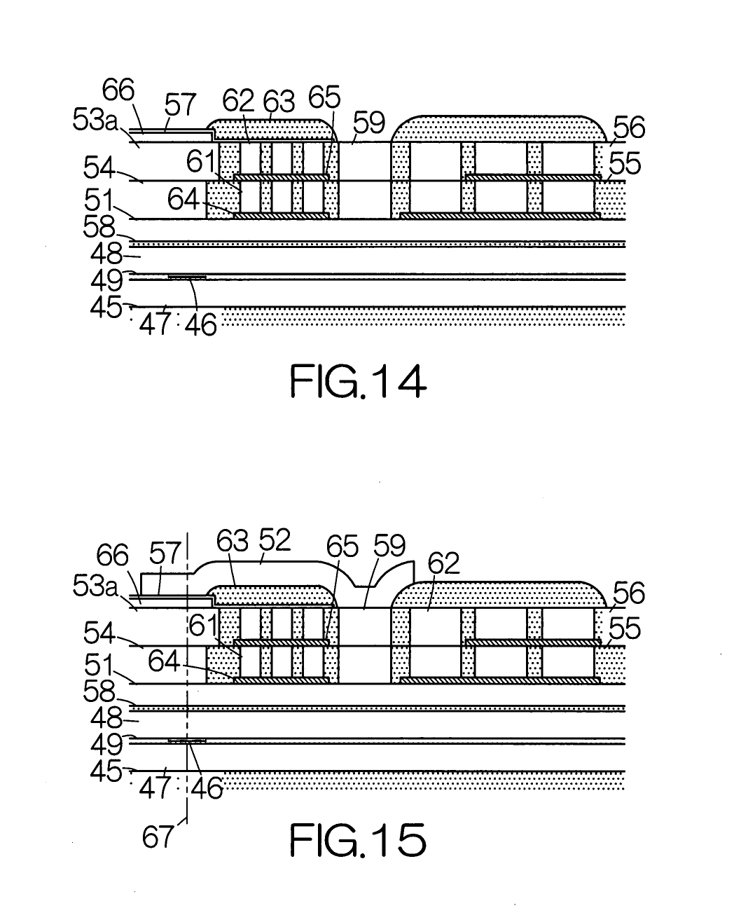

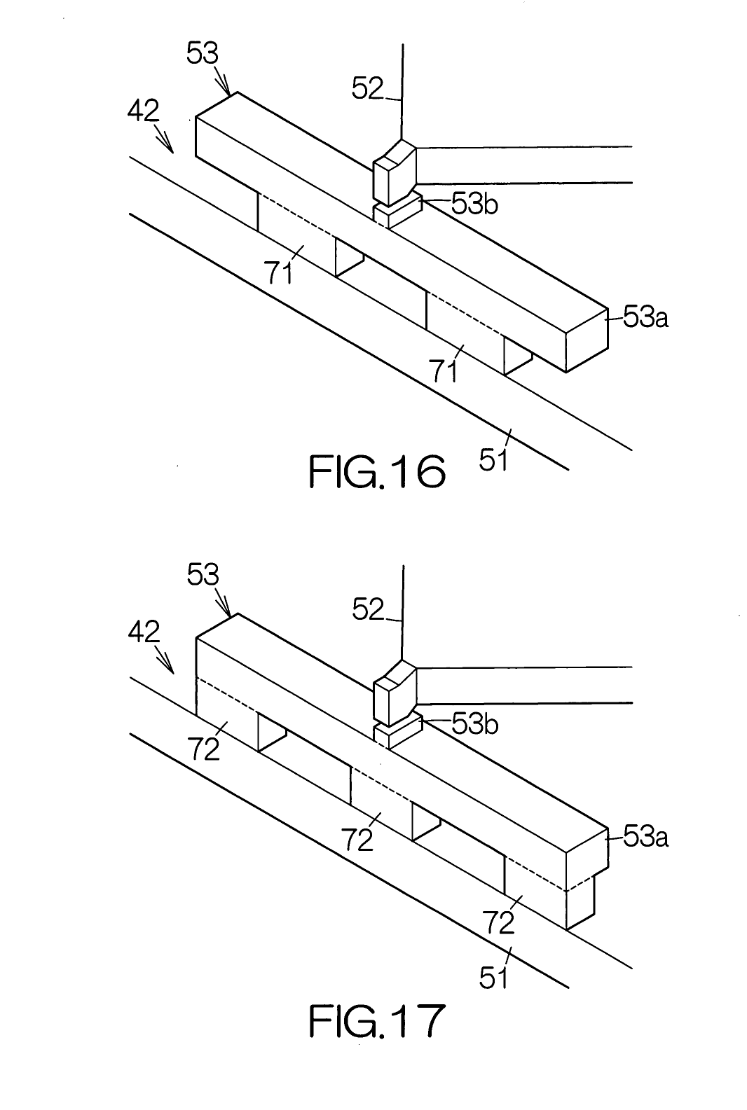

As shown in FIG. 12, the insulating layer 56 is subjected to flattening process in the same manner as described above. The layer body 53a, the thin film coil 62 and the connecting piece 59 get exposed at the flattened surface of the insulating layer 56. As shown in FIG. 13, a magnetic material 66 is formed on the surface of the layer body 53a. Sputtering may be employed to form the magnetic material 66. The magnetic material 66 may have a width equal to that of the layer body 53a in the lateral direction. The non-magnetic gap layer 57 is formed on the surface of the magnetic material 66 at a position outside the contour of the connecting piece 59. Sputtering may be employed to form the non-magnetic gap layer 57. The insulating layer 63 is subsequently formed on the surface of the insulating layer 56 at a position outside the contour of the connecting piece 59, as shown in FIG. 14. The insulating layer 63 covers over the thin film coil 62.

As shown in FIG. 15, the upper magnetic pole 52 is formed on the surface of the insulating layer 56. The upper magnetic pole 52 covers over the insulating layer 63. The insulating material 66 and the tip end of the upper magnetic pole 52 are shaped into an identical width. The front piece 53b is in this manner formed on the surface of the layer body 53a. The overcoat film 44 is subsequently formed on the surface of the upper magnetic pole 52. Polishing process may be applied along an imaginary plane 67 perpendicular to the surface of the lower magnetic pole 51, for example. The air bearing surface 35 is in this manner formed. The magnetoresistive film 46 is exposed at the air bearing surface 35. The read/write head element 41 is in this manner produced.

FIG. 16 illustrates a part of a read/write element 41 according to a second embodiment of the present invention. As shown in FIG. 16, two magnetic pieces 71, 71 are interposed between the lower magnetic pole 51 and the magnetic pole end layer 53, for example. The magnetic pieces 71, 71 are spaced from each other at a predetermined interval. The insulating layer 55 fills a space between the magnetic pole end layer 53 and the lower magnetic pole 51 in the same manner as described above. The total sectional area of the magnetic pieces 71, 71 may be set equal to the sectional area of the aforementioned magnetic piece 54 within an imaginary plane parallel to the surface of the lower magnetic pole 51, for example. Like reference numerals are attached to the structure or components equivalent to those of the aforementioned embodiment. The read/write head element 41 of the type is allowed to enjoy the aforementioned advantages.

FIG. 17 illustrates a part of a read/write element 41 according to a third embodiment of the present invention. As shown in FIG. 17, three magnetic pieces 72, 72, 72 are interposed between the lower magnetic pole 51 and the magnetic pole end layer 53, for example. The magnetic pieces 72, 72, 72 are spaced from one another at a predetermined interval. The insulating layer 55 fills a space between the lower magnetic pole 51 and the magnetic pole end layer 53 in the same manner as described above. The total sectional area of the magnetic pieces 72, 72, 72 may be set equal to the sectional area of the aforementioned magnetic piece 54 within an imaginary plane parallel to the surface of the lower magnetic pole 51, for example. Like reference numerals are attached to the structure or components equivalent to those of the aforementioned embodiment. The read/write head element 41 of the type is allowed to enjoy the aforementioned advantages.

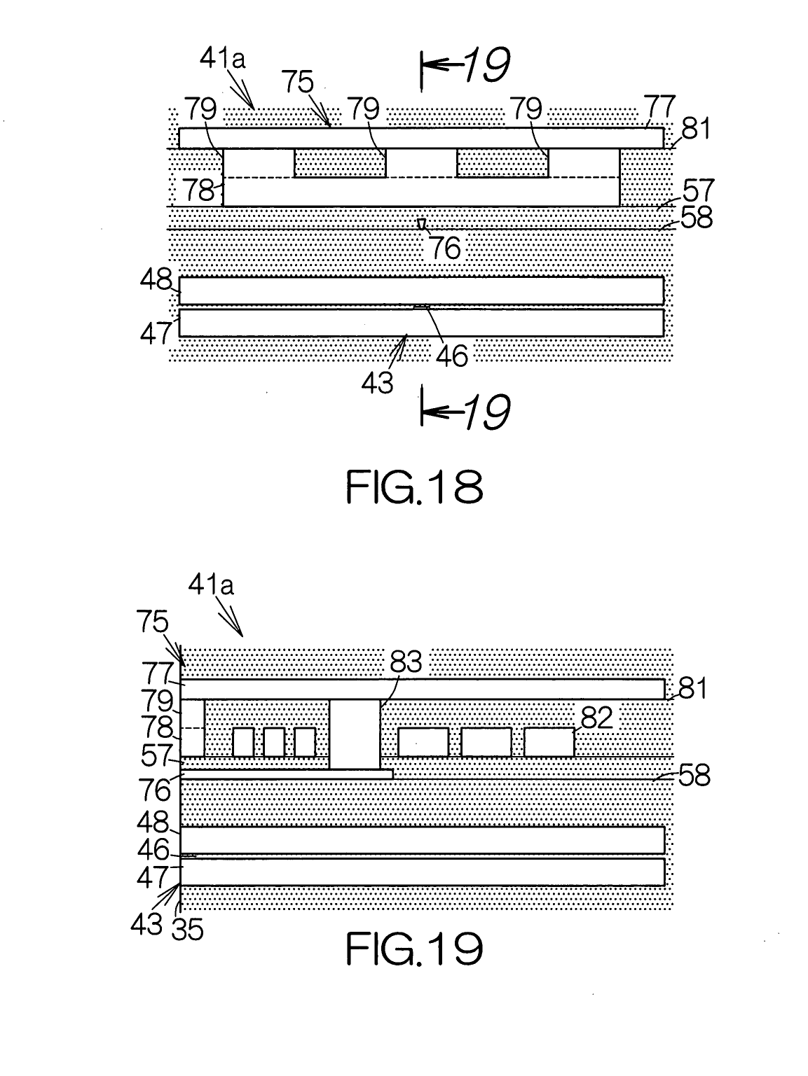

FIG. 18 is an enlarged front view of a read/write head element 41a according to a fourth embodiment of the present invention. A so-called single pole head 75 is employed in place of the aforementioned inductive write head element 42 in the read/write head element 41a. A perpendicular magnetic recording disk may be mounted on the driving shaft of the spindle motor 14. The single pole head 75 includes a main magnetic pole 76 and an auxiliary magnetic pole 77. The main magnetic pole 76 and the auxiliary magnetic pole 77 are designed to extend backward from their front ends exposed at the air bearing surface 35. The main magnetic pole 76 and the auxiliary magnetic pole 77 may be made of a magnetic material such as FeN, NiFe, or the like.

A magnetic pole end layer 78 is located in a space between the main magnetic pole 76 and the auxiliary magnetic pole 77. The magnetic pole end layer 78 has a front end exposed at the air bearing surface 35. The magnetic pole end layer 78 may be made of a magnetic material such as FeN, NiFe, or the like. The magnetic pole end layer 78 is opposed to the main magnetic pole 76. The width of the magnetic pole end layer 78 may be set considerably larger than that of the main magnetic pole 76 in the lateral direction of a recording track.

Three magnetic pieces 79, 79, 79 are interposed between the magnetic pole end layer 78 and the auxiliary magnetic pole 77, for example. The magnetic pieces 79 may be spaced from one another at a predetermined interval. The magnetic pieces 79 connects the magnetic pole end layer 78 to the auxiliary magnetic pole 77 along the air bearing surface 35. The magnetic pieces 79 may be made of a magnetic material such as FeN, NiFe, or the like. A non-magnetic material such as Al₂O₃, namely an insulating layer 81 fills a space around the magnetic pieces 79. The insulating layer 81 in this manner fills a space between the magnetic pole end layer 78 and the auxiliary magnetic pole 77 along the air bearing surface 35.

The aforementioned non-magnetic gap layer 57 is interposed between the main magnetic pole 76 and the magnetic pole end layer 78. When a magnetic field is generated at the magnetic coil, A magnetic flux runs through the main magnetic pole 76, the magnetic pole front layer 78, the magnetic pieces 79 and the auxiliary magnetic pole 77, as described later. The non-magnetic gap layer 57 serves to leak the magnetic flux, running from the main magnetic pole 76 to the auxiliary magnetic pole 77, out of the bottom surface 26. The leaked magnetic flux forms a magnetic field for recordation.

Referring also to FIG. 19, the magnetic coil, namely a thin film coil 82, is embedded in the insulating layer 81 on the non-magnetic gap layer 57. A connecting piece 83 magnetically connects the rear end of the main magnetic pole 76 to the auxiliary magnetic pole 77 at the center of the thin film coil 82. The main magnetic pole 76, the auxiliary magnetic pole 77, the magnetic pole end layer 78 and the magnetic pieces 79 in combination establish a magnetic core extending through the center of the thin film coil 82. The height of the magnetic pieces 79 may be set equal to that of the magnetic pole end layer 78 from the air bearing surface 35. Like reference numerals are attached to the structure or components equivalent to those of the aforementioned embodiments.

When magnetic bit data is to be written, a writing current is supplied to the thin film coil 82. A magnetic field is generated at the thin film coil 82. A magnetic flux in this manner runs through the main magnetic pole 76, the magnetic pole end layer 78, the magnetic pieces 79, the auxiliary magnetic pole 77 and the connecting piece 83. The non-magnetic gap layer 57 serves to leak the magnetic flux out of the bottom surface 26. The leaked magnetic flux forms a magnetic field for recordation. Binary data is in this manner written onto the magnetic recording disk 13.

The insulating layer 81 fills a space between the magnetic pole end layer 78 and the auxiliary magnetic pole 77 along the air bearing surface 35 in the read/write head element 41a. The insulating layer 81 contributes to a reduction in the volume of a magnetic body between the auxiliary magnetic pole 77 and the magnetic pole end layer 78. The volume of a magnetic body is reduced in the single pole head 75. The flux path of the magnetic flux can be narrowed. This results in a reduction in the inductance of the thin film coil 82. A reduced inductance enables a reliable high-frequency recordation. Furthermore, as long as the magnetic pole end layer 78 has a width equal to the width of a conventional magnetic pole end layer in the lateral direction of a recording track, the magnetic field for recordation of a conventional magnitude can be maintained based on the magnetic flux running between the main magnetic pole 76 and the auxiliary magnetic pole 77.

In addition, the thin film coil 82 generates heat in response to the supply of the writing current. The generated heat causes thermal expansion of the non-magnetic gap layer 57, the insulating layer 81, the main magnetic pole 76 and the auxiliary magnetic pole 77. Al₂O₃ as the non-magnetic material for the non-magnetic gap layer 57 and the insulating layer 81 has a coefficient of thermal expansion smaller than that of FeN or NiFe as the material for the main magnetic pole 76 and the auxiliary magnetic pole 77. The thermal expansion is suppressed. A reduced thermal expansion leads to suppression of protrusion of the single pole head 75 out of the air bearing surface 35. This results in avoidance of variation in the flying height of the flying head slider 21.

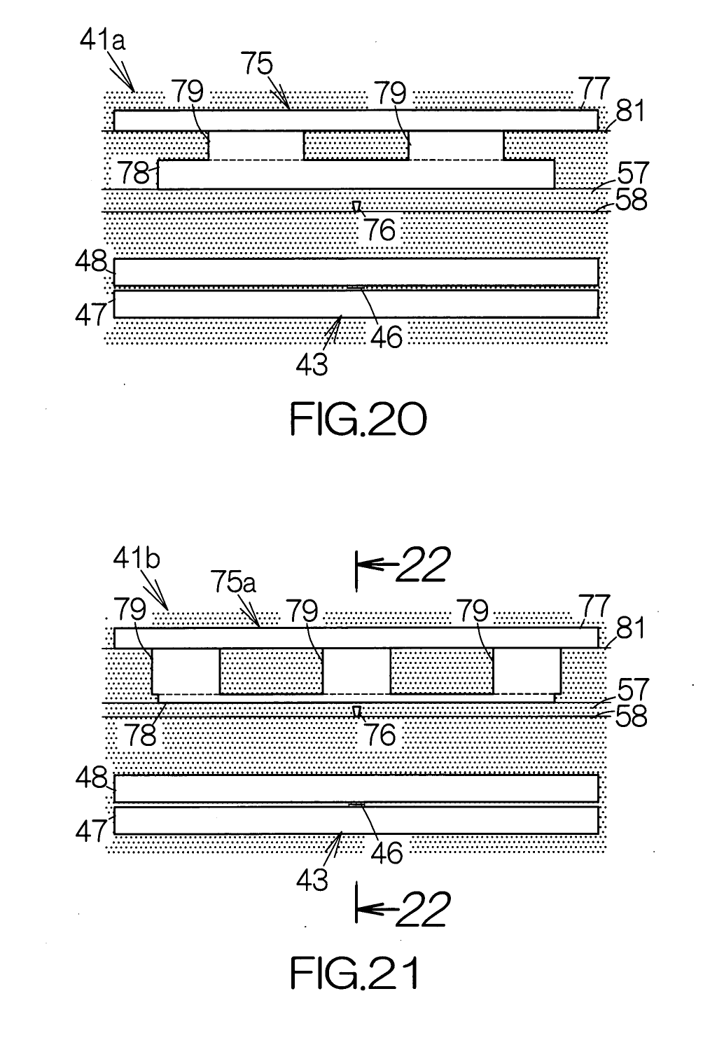

FIG. 20 illustrates a part of a read/write head element 41a according to a fifth embodiment of the present invention. Two magnetic pieces 79, 79 are interposed between the magnetic pole end layer 78 and the auxiliary magnetic pole 77, as shown in FIG. 20. The magnetic pieces 79 are spaced from each other at a predetermined interval. The total sectional area of the magnetic pieces 79, 79 may be equal to that of the aforementioned magnetic pieces 79, 79, 79 within an imaginary plane parallel to the surface of the auxiliary magnetic pole 77, for example. Like reference numerals are attached to the structure or components equivalent to those of the aforementioned embodiments. The read/write head element 41a of this type is allowed to enjoy the aforementioned advantages.

As shown in FIG. 21, a read/write head element 41b according to a sixth embodiment may be incorporated in the flying head slider 21 in place of the aforementioned read/write head elements 41, 41a. A single pole head 75a is incorporated in the read/write head element 41b. A perpendicular magnetic recording disk may be incorporated in the hard disk drive 11. The magnetic pole end layer 78 serves as a so-called trailing shielding between the main magnetic pole 76 and the auxiliary magnetic pole 77. The magnetic pole end layer 78 is capable of absorbing an excessive flux leaked out of the main magnetic pole 76.

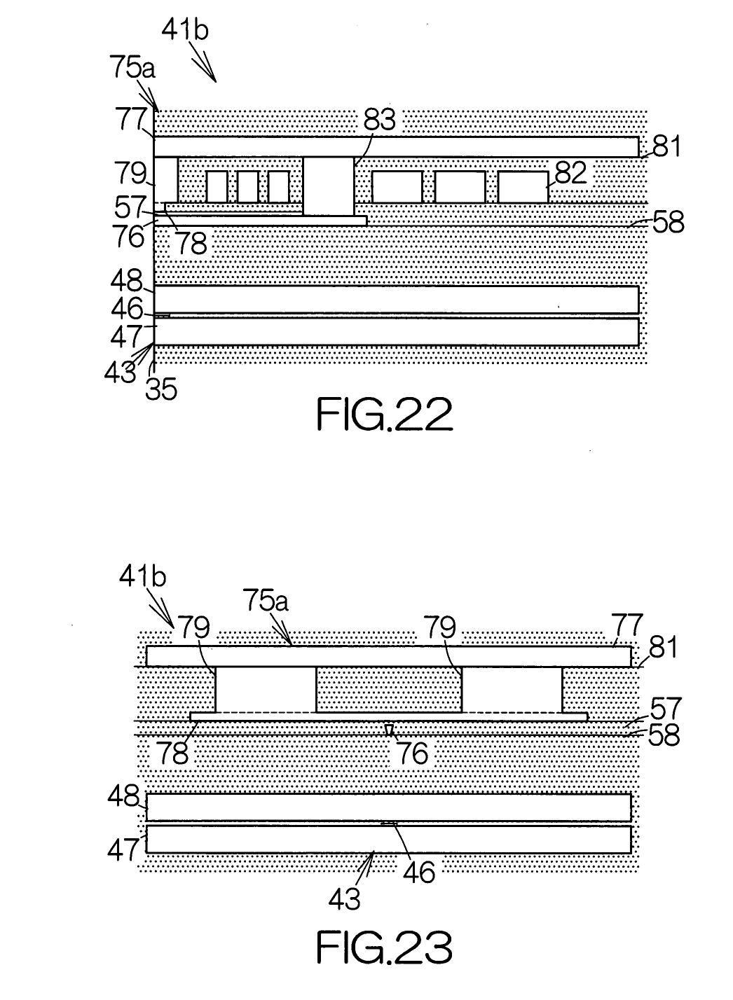

Referring also to FIG. 22, the height of the magnetic pole end layer 78 is set smaller than that of the magnetic pieces 79 from the air bearing surface 35. Like reference numerals are attached to the structure or components equivalent to those of the aforementioned embodiments. As shown in FIG. 23, two magnetic pieces 79, 79 may be interposed between the magnetic pole end layer 78 and the auxiliary magnetic pole 77, for example. The read/write head element 41b is allowed to enjoy the aforementioned advantages.

What is claimed is:

1. A magnetic head comprising:
a first magnetic pole extending backward from a front end exposed at a medium-opposed surface;
a second magnetic pole extending backward from a front end exposed at the medium-opposed surface, said second magnetic pole magnetically connected to the first magnetic pole at a position backward from the front end of the second magnetic pole;
a magnetic pole end layer having a front end exposed at the medium opposed surface, said magnetic pole end layer opposed to the second magnetic pole in a space between the first and second magnetic poles;
at least one magnetic piece located between the magnetic pole end layer and the first magnetic pole so as to connect the magnetic pole end layer and the first magnetic pole to each other along the medium-opposed surface; and
a non-magnetic material located between the magnetic pole end layer and the first magnetic pole to fill a space between the magnetic pole end layer and the first magnetic pole along the medium-opposed surface.

2. A storage medium drive comprising:
an enclosure; and
a magnetic head enclosed in the enclosure, wherein the magnetic head comprises:
a first magnetic pole extending backward from a front end exposed at a medium-opposed surface;
a second magnetic pole extending backward from a front end exposed at the medium-opposed surface, said second magnetic pole magnetically connected to the first magnetic pole at a position backward from the front end of the second magnetic pole;
a magnetic pole end layer having a front end exposed at the medium opposed surface, said magnetic pole end layer opposed to the second magnetic pole in a space between the first and second magnetic poles;
at least one magnetic piece located between the magnetic pole end layer and the first magnetic pole so as to connect the magnetic pole end layer and the first magnetic pole to each other along the medium-opposed surface; and
a non-magnetic material located between the magnetic pole end layer and the first magnetic pole to fill a space between the magnetic pole end layer and the first magnetic pole along the medium-opposed surface.
